(19) United States
(12) Patent Application Publication
(10) Pub. No.: US 2011/0264374 A1
(43) Pub. Date: Oct. 27, 2011

(54) Method, Computer Program Product and System for Individual Assessment of Alcohol Sensitivity

(75) Inventors: Bankole A. Johnson, Charlottesville, VA (US); Nassima Ait-Daoud Tiouririne, Charlottesville, VA (US); Marc D. Breton, Charlottesville, VA (US); Boris P. Kovatchev, Charlottesville, VA (US)

(73) Assignee: UNIVERSITY OF VIRGINIA PATENT FOUNDATION, Charlottesville, VA (US)

(21) Appl. No.: 12/674,348

(22) PCT Filed: Aug. 20, 2008
(86) PCT No.: PCT/US08/73738

§ 371 Date: Mar. 8, 2010

Related U.S. Application Data
(60) Provisional application No. 60/965,657, filed on Aug. 21, 2007.

(51) Int. Cl. G06F 19/00

(52) U.S. Cl. 702/19

(57) ABSTRACT

Methods/computer methods and systems/computer systems for the evaluation of two idiosyncratic indices of alcohol intoxication: the Alcohol Sensitivity Index (ASI), and the brain-specific Cognitive Alcohol Sensitivity Index (CASI). The two indices are based on the new Metabolic and Cognitive Minimal Models of Alcohol Dynamics, and are derived from specific clinical protocols, accompanied by specific data analysis procedures. The two indices may be derived from specific clinical and cognitive assessment protocols, accompanied by specific data analysis procedures based on the new metabolic and cognitive minimal models of alcohol dynamics.

### RELATED APPLICATIONS

The present invention claims priority from U.S. Provisional Application Ser. No. 60/965,657, filed Aug. 21, 2007, entitled “Method, Computer Program Product and System for Individual Assessment of Alcohol Sensitivity: The Alcohol Sensitivity Index;” the disclosure of which is hereby incorporated by reference herein in its entirety.

### BACKGROUND OF THE INVENTION

Mechanisms of Alcohol Intoxication: Ethyl Alcohol, also known as ethanol, is the substance found in alcoholic beverages. Ethyl alcohol is a colorless liquid that mixes in all proportions and therefore readily distribute throughout the body in the aqueous blood stream after consumption. Also because of this water solubility, it readily crosses important biological membranes, such as the blood brain barrier. After it reaches the brain, alcohol affects multiple molecular targets, some of which remain unknown. In particular, alcohol causes GABA receptors to remain open longer allowing more chloride ions to enter brain cells and therefore causing relaxation, sedation and overall inhibition of brain activity. At low concentrations alcohol sensitises the N-methyl-D-aspartate (NMDA) system, which stimulates areas of the brain associated with pleasure such as the nuccleus accumbuns. With chronic exposure to alcohol, the brain undergoes long lasting biochemical changes including neuroadaptation of the ion channels. Alcohol is also responsible for structural changes in the brain such as loss of neuronal mass and brain shrinkage responsible for impaired cognitive function. Interestingly maximum quantity of alcohol consumed such as in binge drinking seems to be a better predictor of alcohol related impairment. Hence, understanding the elimination process of alcohol will help us to a certain degree predict the extent of the neuro-adaptation that take place with chronic alcohol use.

Alcohol Metabolism: When we consume alcohol, the majority of it is absorbed from the stomach (approx. 20%) and the small intestine (approx. 80%). In general drinking more alcohol within a certain period of time will result in increased blood alcohol concentrations due to more alcohol being available to be absorbed into the blood. More than 90% of alcohol that enters the body is completely metabolized in the liver. The remainder 10% is not metabolized and is excreted in the sweat, urine, and breath. There are several routes of metabolism of alcohol in the body. The major pathways involve the liver and in particular the oxidation of alcohol by alcohol dehydrogenase to produce acetaldehyde, a highly toxic substance. The second step is catalyzed by acetaldehyde dehydrogenase. This enzyme converts acetaldehyde to acetic acid, which is a non toxic metabolite. Acetic acid is eventually metabolized to carbon dioxide and water. Another system in the liver oxidizes ethanol via the enzyme cytochrome P450IIE1 (CYP2E1). This microsomal ethanol-oxidizing system or MEOS seems to play a more important role at higher concentrations of ethanol.

Individual Differences in the Rate of Alcohol Metabolism: There are genetic variations in the P450E1 enzyme system, which lead to individual differences in the rate of ethanol metabolism among people [16]. The rate of alcohol metabolism depends, in part, on the amount of metabolizing enzymes in the liver, which varies among individuals and appears to have some genetic determinants. In general, after the consumption of one standard drink, the amount of alcohol in the drinker's blood peaks within 30 to 45 minutes. (A standard drink is defined as 12 ounces of beer, 5 ounces of wine, or 1.5 ounces of 80-proof distilled spirits, all of which contain the same amount of alcohol.). The concentration of alcohol in the entire body, including the brain, is always less than that in the blood, because human tissues contain a much lower percentage of water compared to the blood. However, organs having a rich blood supply such as the brain will quickly reach alcohol equilibrium with arterial blood. This explains why most people experience intoxication very quickly after taking a couple of drinks, then rapidly sober up as other bodily tissues such as the muscle with less blood supply start to absorb alcohol from the blood meaning less alcohol is circulating in the bloodstream.

Mathematical Modeling of the Pharmacokinetics of Ethanol: In early studies, ethanol elimination has been assumed to follow a zero order metabolism, which means that constant amount of alcohol is eliminated per unit of time regardless of blood levels. Later, a number of studies have concluded that elimination of ethanol follows different clearance models including first-order kinetic and a combination of zero and first order kinetics together. This, coupled with individual genetic differences, makes it hard to predict blood alcohol concentration based on total amount of alcohol consumed [33]. Since the early 20^{th} century, efforts have been directed towards the understanding of alcohol dynamics in human, and more specifically the blood concentration of ethanol. Numerous models have been devised since, beginning with the Widmark zero order model assuming a constant clearance rate β₀ and modeling the human body as one compartment, [35, FIG. 1]. See FIG. 1.

Deeper understanding of the processes involved and novel measuring tools have allowed more precise measurement and understanding of ethanol pharmacokinetics and the development of more complex non-linear models [21, 23, 24, 32]. Most of these models are compartmental, e.g. they represent the human body as a set of homogeneous compartments of specific concentration and volume linked by diffusion or rate-limited pathways. The study of ethanol kinetics in vivo has lead to a better representation of the ethanol-aldehyde-acetate process, leading to Norberg's model of alcohol dynamics [21, See FIG. 2], which introduced Michaelis-Menten rate of alcohol clearance. It is now widely accepted that alcohol clearance is a Michaelis-Menten controlled reaction: enzyme enhanced chemical reaction with limited supply [20]. These previously introduced models allowed for a mathematical description of alcohol clearance following intravenous alcohol injection [See FIG. 3].

However, the dynamics of orally ingested alcohol has not been well quantified. The compartmental model in FIG. 2 cannot reproduce the observed dynamics of blood alcohol level (BAL) after alcohol ingestion presented in FIG. 4. In particular, the rate of increase in BAL after alcohol ingestion is poorly described. See FIG. 4.

In addition, the existing models fail to provide specific testing protocols, which would allow the estimation of idiosyncratic indices of metabolic and/or cognitive sensitivity to alcohol. This last point is particularly relevant to the present invention disclosure, allowing us to build it on our previous studies of human glucose-insulin dynamics.

Insulin Resistance and Insulin Sensitivity in Diabetes: Glucose-insulin dynamics has been mathematically characterized by Bergman and Cobelli's now classic Minimal Model [3, 4, FIG. 5] and by a number of subsequent studies [2, 4, 5, 8, 22]. The data collection techniques of choice have been euglycemic or hyperglycemic clamp [13, 14], or intra-venous glucose tolerance test [3, 34]; various mathematical methods have been used to analyze the data [18, 28]. See FIG. 5.

A newer c-peptide minimal model allowed for a more precise evaluation of β-cell function [29, 30, 31]. Further research showed that oral glucose tolerance test could be used as well [6, 7, 10, 11, 12]. The oral models have been extensively validated in the nondiabetic population; work is being done to assess their domain of validity in diabetes [1].

Of a particular relevance to this invention disclosure is that the glucose minimal model allows estimating individual markers of insulin sensitivity (SI), β-cell function, and insulin action.

A note on terminology: the state of insulin resistance, in which a given amount of insulin produces a less-than-expected effect glucose metabolism, has been known for over 55 years (19). The syndromes of insulin resistance include obesity, glucose intolerance, diabetes, syndrome X, etc. (15, 26). Insulin sensitivity (SI) is an index defined by Bergman and Cobelli in 1979 (3) as the dependence of fractional glucose disappearance on plasma insulin. SI is mathematically derived from the Minimal Model of glucose regulation (3) and since its introduction became an accepted standard for quantifying insulin-glucose dynamics. The two are inversely related.

Following the ground work of Bergman and Cobelli [3] in physiological modeling we adopt in this paper a minimal model approach to quantifying the metabolic dynamics of orally ingested ethanol. Minimal Model means that we use the mathematically simplest model that accurately predicts measured quantities, in this case blood ethanol concentration (or blood alcohol level, BAL) following oral alcohol ingestion [FIG. 4]. An aspect of an embodiment may implement an aspect of the non linear model presented by Norberg [23, FIG. 2], adopting literature values for the parameters of Michaelis-Menten kinetics, diffusion [23, 24], and gastric emptying of ethanol [9, 25].

### SUMMARY OF THE INVENTION

An aspect of an embodiment of the present invention may utilize mathematical models of human glucose metabolism of which can be appropriately modified or created to reflect the metabolism of ethanol, following alcohol ingestion. This approach opened the possibilities for idiosyncratic assessment of the reaction of a person's metabolic system to alcohol consumption and intoxication. In turn, this also allows for the laboratory assessment of individual alcohol sensitivity thresholds and for the computation of individual Alcohol Sensitivity Index (ASI), to some extent similar to the Insulin Sensitivity Index [SI, 3]—a key component in the assessment and treatment of diabetes. The availability of individual ASI would allow for precise assessment and tailored treatment tar of the metabolic components of the alcohol addiction.

An aspect of various embodiments of the present invention comprises, but not limited thereto, new methods/computer methods, systems/computer systems and algorithms for the evaluation of two idiosyncratic indices of alcohol intoxication: the Alcohol Sensitivity Index (ASI), and the brain-specific Cognitive Alcohol Sensitivity Index (CASI). The two indices are based on the new Metabolic and Cognitive Minimal Models of Alcohol Dynamics, and are derived from specific clinical protocols, accompanied by specific data analysis procedures. The two indices may be derived from specific clinical and cognitive assessment protocols, accompanied by specific data analysis procedures based on the new metabolic and cognitive minimal models of alcohol dynamics.

An aspect of various embodiments of the present invention may pertain directly to, but not limited thereto, one or more of the following:

Enhancement of existing alcohol intoxication assessment protocols by introducing a data interpretation component capable of evaluating individual alcohol dynamics, alcohol sensitivity, and associated cognitive impairments;

Enhancement of existing alcohol addiction treatment protocols by introducing a data interpretation component capable of evaluating individual alcohol sensitivity and assisting in the design of idiosyncratic treatment regiments;

Enhancement by the same features of laboratory devices intended to assist the assessment and treatment of alcohol addiction; and

Enhancement by the same features of software that retrieves blood alcohol level profiles—such software can be used in health-care, forensic, work-safety assessment, and other settings. The software can reside on personal computers, or be used via Internet portal.

An aspect of various embodiments of the present invention includes, but not limited thereto, clinical protocols, a mathematical method, and a computer program product for computing an estimate of ASI and CASI using BAL readings recorded during a predetermined period following alcohol ingestion.

An aspect of an embodiment or partial embodiment of the present invention (or combinations of various embodiments in whole or in part of the present invention) comprises a method (such as a computer implemented method) for evaluating idiosyncratic estimates of alcohol sensitivity of a subject, whereby the estimates being represented by one or more idiosyncratic indices. The idiosyncratic indices may comprise: calculating an alcohol sensitivity index (ASI), and/or calculating a cognitive alcohol sensitivity index (CASI). The method may comprise providing a metabolic minimal simulation model of alcohol dynamics (MMSMAD) following oral intake (or other type of intake, ingestion, input, injection, or receipt) by the subject for computing the alcohol sensitivity index (ASI). The method may also comprise providing cognitive minimal simulation model of alcohol dynamics (CMSMAD) for computing the cognitive alcohol sensitivity index (CASI).

An aspect of an embodiment or partial embodiment of the present invention (or combinations of various embodiments in whole or in part of the present invention) comprises a system for evaluating idiosyncratic estimates of alcohol sensitivity of a subject, whereby the estimates are represented by one or more idiosyncratic indices. The system comprising a processor that determines the idiosyncratic indices by: calculating an alcohol sensitivity index (ASI), and/or calculating a cognitive alcohol sensitivity index (CASI). The system of may also comprise a metabolic minimal simulation model of alcohol dynamics (MMSMAD) module for computing the alcohol sensitivity index (ASI). The system may comprise a cognitive minimal simulation model of alcohol dynamics (CMSMAD) module for computing the cognitive alcohol sensitivity index (CASI).

An aspect of an embodiment or partial embodiment of the present invention (or combinations of various embodiments in whole or in part of the present invention) comprises a computer program product comprising a computer useable medium having computer program logic for enabling at least one processor in a computer system for evaluating idiosyncratic estimates of alcohol sensitivity of a subject, whereby the estimates being represented by one or more idiosyncratic indices. The evaluating approach of the computer program logic comprises calculating an alcohol sensitivity index (ASI), and/or calculating a cognitive alcohol sensitivity index (CASI). The computer program product may comprise of the processor being adapted for calculating a metabolic minimal simulation model of alcohol dynamics (MMSMAD) module for computing the alcohol sensitivity index (ASI). The computer program product may comprise of the processor being adapted for calculating a cognitive minimal simulation model of alcohol dynamics (CMSMAD) module for computing the cognitive alcohol sensitivity index (CASI).

These and other advantages and features of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a schematic illustration of Widmark's zero order model.

FIG. 2 provides a schematic illustration of Norberg's alcohol clearance model featuring Michaelis-Menten dynamics. Suitable for description of intravenous (i.v.) ethanol injection.

FIG. 3 provides a graphical illustration of blood alcohol level following intravenous (i.v.) ethanol injection.

FIG. 4 provides a graphical illustration of blood alcohol level following oral alcohol ingestion.

FIG. 5 provides a schematic illustration of Bergman and Cobelli's Minimal Model of Glucose-Insulin Dynamics: Introduces the SI—the gold-standard insulin sensitivity assessment.

FIG. 6 provides a graphical illustration of common features of a clinical testing protocol collecting data for an individual ethanol dynamics profile. The BAL sampling can be done directly through blood samples, or using a breath analyzer. Cognitive testing may accompany the sampling of BAL to detect potential cognitive impairments.

FIG. 7 provides a schematic illustration of the Metabolic Minimal Model of Alcohol Dynamics following oral alcohol intake—used as the basis of various embodiments of the present invention. The model allows the computation of idiosyncratic Alcohol Sensitivity Index (ASI). The ASI is derived as a function of the dynamics of the fluxes between the compartments of this model.

FIG. 8 provides a graphical illustration of the estimation of ASI using simulation of the Minimal Model of Alcohol Dynamics at different average numbers of drinks per day.

FIG. 9 provides a schematic illustration of the Cognitive Minimal Model of Alcohol Dynamics, which includes a separate brain compartment. This yields a version of the alcohol sensitivity index—the Cognitive ASI (CASI)—focused on the cognitive aspects of alcohol intoxication. The CASI is derived as a function of the dynamics of the fluxes between the compartments of this model. Because alcohol level in the brain (BrAL) is difficult to measure in vivo, a surrogate measure is developed, which uses the score from the rapid visual information processing task (RVIPT) and derives an estimate of BrAL from its score, CIPS.

FIG. 10 provides a graphical illustration of Minimum BAL during daytime (7 AM-11 PM) as a function of average drinks per day.

FIGS. 11(A)-(B) provide a graphical illustration of system phase transition from stable to unstable dynamics indicated by Poincaré plot of the system attractor at about 5 standard drinks/day on average. FIGS. 11(A)-(B) represent either 4 drinks or 6 drinks, respectively.

FIG. 12 provides a graphical illustration of minimum BAL during the night (11 PM-7 AM) as a function of average drinks during the day (7 AM-11 PM).

FIG. 13 is a functional block diagram for a computer system for implementation of an exemplary embodiment or portion of an embodiment of present invention.

FIG. 14 is a schematic block diagram for a system or related method of an embodiment that evaluates and accesses the idiosyncratic estimates of alcohol sensitivity of a subject.

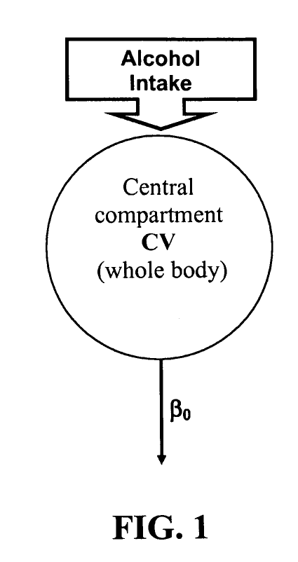

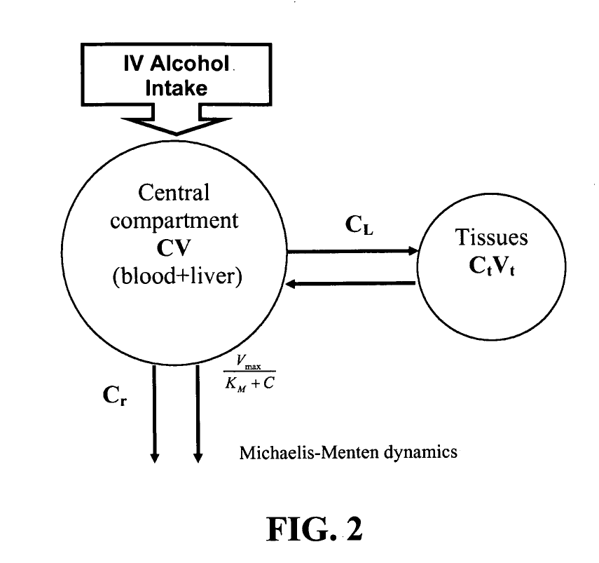

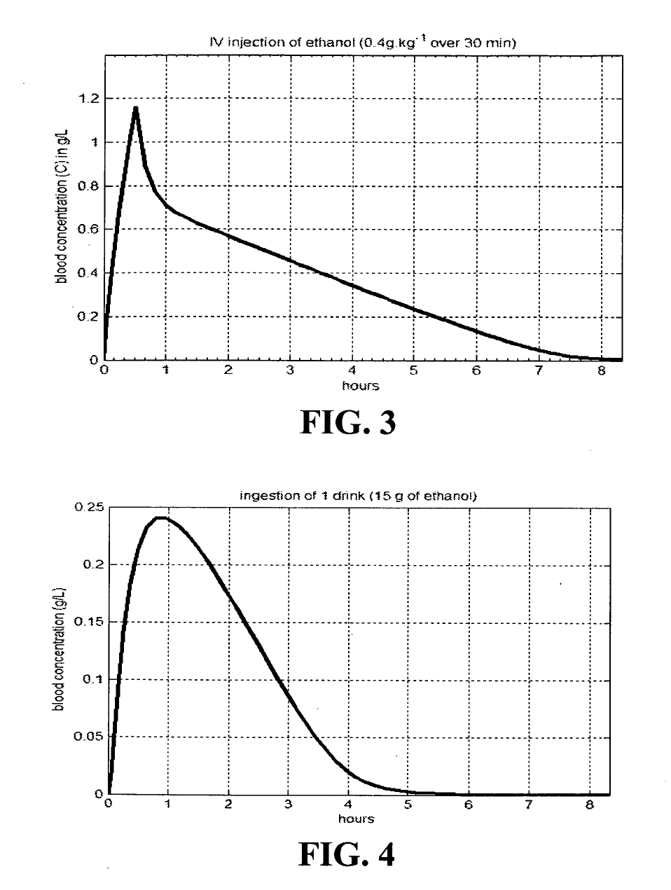

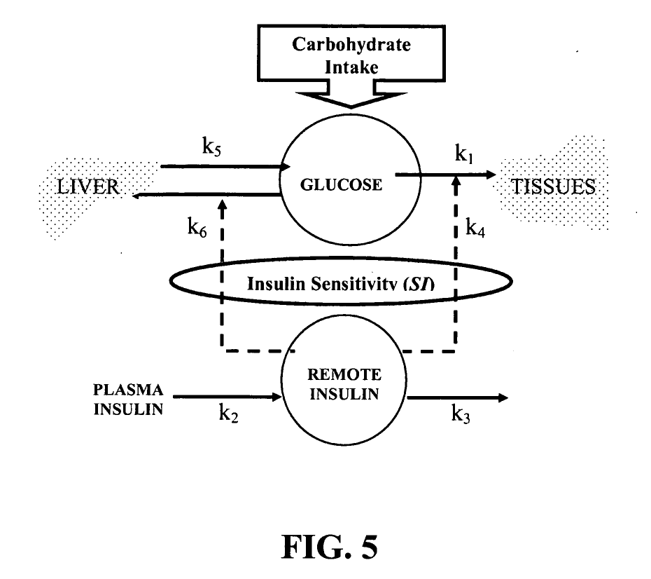

### DETAILED DESCRIPTION OF THE INVENTION

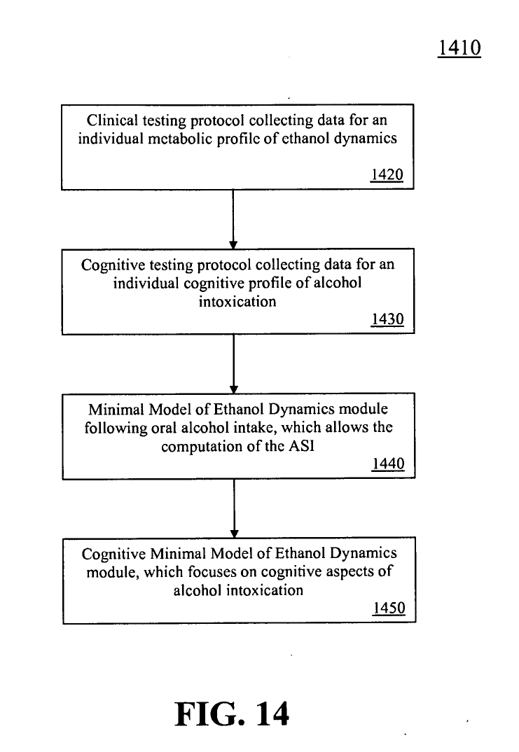

An aspect of various embodiments of the present invention may have, but not limited thereto, five principal components, which work together to bring about idiosyncratic estimates of alcohol sensitivity, numerically represented by the ASI and the CASI. These components include:
1. A clinical testing protocol collecting data for an individual metabolic profile of ethanol dynamics;
2. A cognitive testing protocol collecting data for an individual cognitive profile of alcohol intoxication;
3. The Metabolic Minimal Model of Ethanol Dynamics following oral alcohol intake, which allows the computation of the ASI;
4. The Cognitive Minimal Model of Ethanol Dynamics, which focuses on cognitive aspects of alcohol intoxication;
5. Data processing software.
   Referring to FIG. 14, an aspect of an embodiment or partial embodiment (or combinations of various embodiments in whole or in part) of the present invention evaluates and accesses the idiosyncratic estimates of alcohol sensitivity of a subject that provides a system or related method 1410 that may include at least one of the following elements:
   provides and/or receives clinical testing protocol collecting data for an individual metabolic profile of ethanol dynamics 1420;
   provides and/or receives cognitive testing protocol collecting data for an individual cognitive profile of alcohol intoxication 1430;
   provides a Metabolic Minimal Model of Ethanol Dynamics module following oral alcohol intake, which allows the computation of the ASI 1440; and
   provides a Cognitive Minimal Model of Ethanol Dynamics module 1450, which focuses on cognitive aspects of alcohol intoxication.

Clinical Testing Protocol Collecting Metabolic Data:

In general, the Alcohol Sensitivity Index will describe the metabolic dynamics of intoxication, including the post-load decay of BAL and the metabolic vulnerability of a person to alcohol intoxication. In order to capture the kinetics of BAL, several methods can be used, including blood sampling or breath analysis. An aspect of various embodiments of the present invention methods may have the following common features:
1. A baseline sample should be obtained;
2. Standard drink (15 g. ethanol, or may be set to other levels as desired or required) should be given at time t=0 via self-administration (or as desired or required);
3. In order to account for the faster rise and slower decay of the BAL curve, more frequent sampling (e.g. every 5-10 minutes, or assisted as desired or required) should be done during BAL rise (e.g. the first hour after alcohol ingestion, or other duration as desired or required); during the rest of the time less frequent sampling is permissible;
4. The entire test should continue approximately 6 hours (or other duration as desired or required);
5. The rate of BAL rise needs to be standardized by the rate of alcohol self-administration to derive a purely metabolic, independent from behavior, rate of BAL increase per gram of ingested alcohol per minute for each person. If the entire standard drink is ingested at t=0, the average across people BAL profile should be similar to the one presented in FIG. 4.

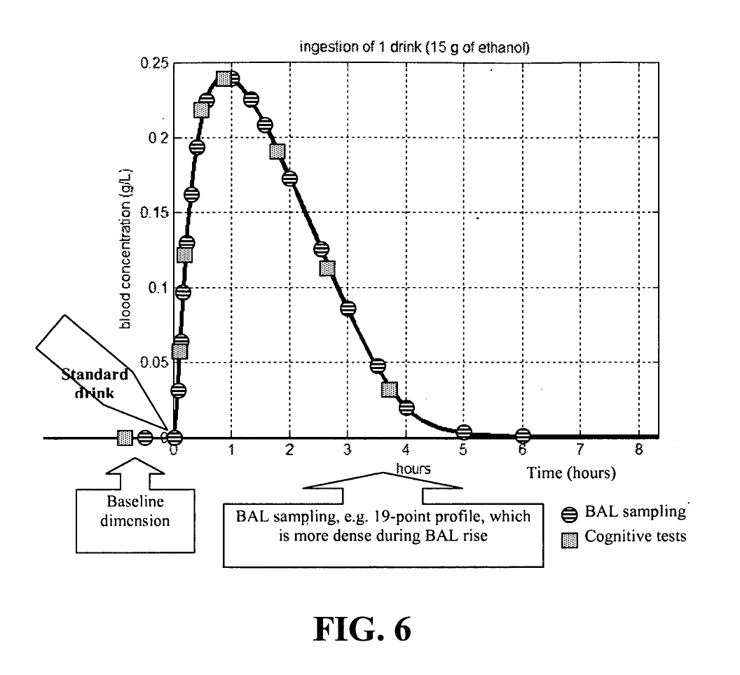

For example, the clinical data collection can use the 19-point sampling protocol presented in FIG. 6. To some extent, this protocol may be similar to the standard profile used for determination of insulin resistance [11], and is modified to account for the specifics of ethanol dynamics. Under this protocol BAL samples are collected at times (t)=−30, 0, 5, 10, 15, 20, 30, 40, 50, 60, 75, 90, 120, 150, 180, 210, 240, 300, and 360 minutes (or other duration or intervals as desired or required). Time 0 is the time of initiation of oral alcohol intake. The total amount of ingested alcohol is equivalent to one standard drink (15 g. ethanol) and therefore the average BAL profile of a person would be similar to the profile presented in FIG. 4. The BAL measurement prior to initiation of alcohol intake provides a baseline used for calibration; denser sampling is anticipated during the expected increase in BAL and less frequent sampling is anticipated during BAL decay. See FIG. 6.

Cognitive Testing Protocol Collecting Cognitive Impairment Data:

The Cognitive Alcohol Sensitivity Index includes the ASI, plus a transfer function, which allows quantifying a surrogate measure of alcohol level in the brain (BrAL) as a function of cognitive impairment. While such a surrogate measure may not be directly proportional to BrAL, it captures the principal effect of interest—cognitive impairment associated with alcohol intoxication. Thus, the CASI is not a purely physiological measure (as the ASI), but also has a cognitive/behavioral component.

The computation of CASI requires cognitive testing to be performed in parallel with BAL measurement. Various methods for cognitive testing could be applied; however, some or all methods should have one or more of the following common features:
1. A baseline sample should be obtained;
2. Standard drink (15 g. ethanol, or may be set to other levels as desired or required) should be given at time t=0 via self-administration;
3. In order to account for the faster deterioration and slower restoration of cognitive ability with increasing/decaying BAL, more frequent test (e.g. every 10 minutes, or duration as desired or required) should be done during BAL rise (e.g. the first hour after alcohol ingestion); during the rest of the time less frequent sampling is permissible.

For example, the cognitive testing can use the 8-point sampling protocol (or other level of sampling as desired or required) presented in FIG. 6 and the rapid visual information processing task (RVIPT). The RVIPT is a recognized test of attention and mental concentration (17, 27). In the RVIPT, subjects monitor digits that are presented sequentially on a computer screen at a rate of 100/min (other frequency as desired or required). Subjects are instructed to detect and respond to targets of three consecutive even or odd digits as quickly as possible. Independent measures are made of both the speed and accuracy of decision making. These measurements are recorded for each trial block: hits—correct responses within 600 ms (or other duration as desired or required); delayed hits—responses occurring between 600 ms and 1200 ms (or other duration as desired or required) after the target; false alarms—incorrect responses, and reaction time for both hits and delayed responses.

Under this protocol, sections of the RVIPT is administered for 1-2 minutes at times (t)=−30, 10, 20, 40, 60, 100, 160, and 220 minutes (or other duration or intervals as desired or required), where time 0 is the time of initiation of oral alcohol intake. A composite score information processing score (CIPS) is then derived.

The Metabolic Minimal Model of Ethanol Dynamics:

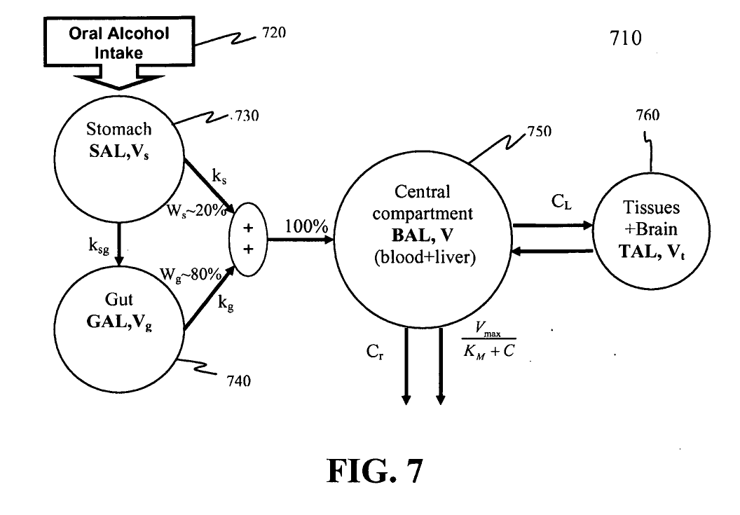

FIG. 7 presents the compartments included in the Minimal Model of Ethanol Dynamics system 710. To properly represent oral alcohol intake, the model needs to include at least two compartments of the gastro-intestinal (GI) tract: stomach 730 and gut 740. Following the minimal model approach we do not necessarily need to add more compartments, unless it is proven that the two-compartment GI tract model is inherently insufficient, or for other desired or required purpose. Further, the processes linking these compartments include one-way diffusions from the stomach and the gut into the bloodstream and/or liver related compartment 750, as well as the tissues and brain related compartment 760. Final assumptions of the model include gastric emptying following an exponential decay with certain half-life (e.g. 50 minutes (other duration as desired or required), [36]) and the proportion of gastric diffusion Wₛ from the stomach vs. diffusion from the gut W_{g} (e.g. Ws=20% vs. Wg=80%, [24], or other percentage or ratio as desired or required). See FIG. 7.

In the system model compartments the alcohol concentration is labeled *AL, where *=S for “stomach,”*=G for “gut,”*=B for blood, and *=T for “tissues.” The volume of each compartment is labeled by Vᵢ with an index “i” corresponding to that compartment. The differential equations governing the processes depicted in FIG. 7 are as follows:
1. Ethanol transport from the stomach to the gut with a rate constant k_{sg} and diffuses from the stomach into the bloodstream, with a rate constant k_{g}.

$$\frac{\partial SAL}{\partial t} = \frac{1}{{V}_{S} W} ( I ( t ) - {k}_{S} SAL - {k}_{SG} SAL )$$

2. Ethanol diffuses from the gut into the bloodstream with a rate constant k_{g}.

$$\frac{\partial GAL}{\partial t} = \frac{1}{{V}_{G} W} ( - {k}_{G} GAL + {k}_{SG} SAL )$$

3. The total ethanol diffusion into the blood stream is then given by the combination of diffusions from the stomach and the gut.

D(t)=k_{G}GAL+kₛSAL
4. Michaelis-Menten clearance of ethanol from the bloodstream;

$$C ( t ) = \frac{{V}_{m}}{{K}_{m} + BAL ( t )} BAL ( t )$$

5. Two-way diffusion of ethanol between the bloodstream and tissues/liver, including ethanol transport to the brain.

$$\{ \begin{matrix}\frac{\partial BAL}{\partial t} = \frac{1}{{V}_{C} W} ( D ( t ) + {C}_{d} ( TAL ( t ) - BAL ( t ) ) - {C}_{r} BAL ( t ) - C ( t ) ) \\ \frac{\partial TAL}{\partial t} = \frac{{C}_{d}}{{V}_{T} W} ( BAL ( t ) - TAL ( t ) )\end{matrix}$$

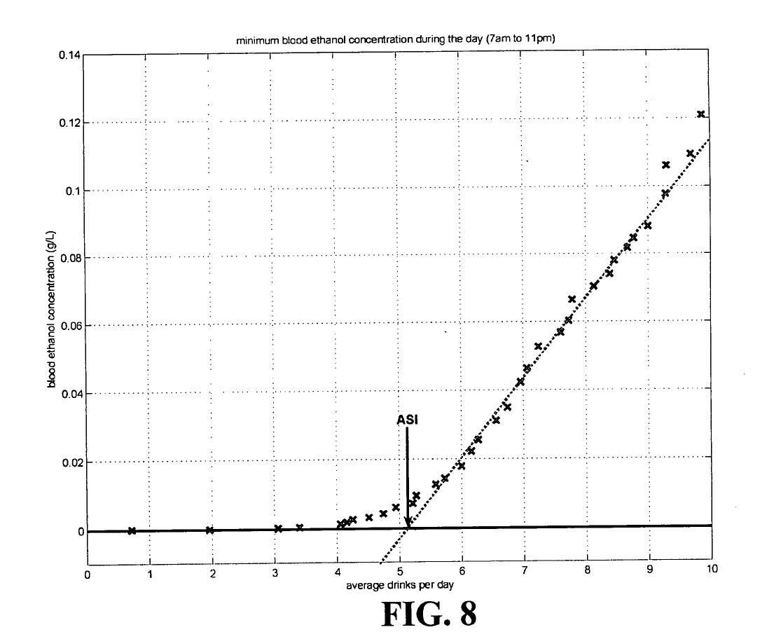

Given the alcohol intoxication profiles recorded during the clinical data collection protocol, standard non linear least squares procedures are used to estimate the parameters of the system. The baseline daytime brain ethanol concentration is simulated for average drinks per day ranging between 1 and 10 (or other ranges as desired or required). A line is fit through the points ranging between 0.01 g/L and 0.1 g/L. ASI is then defined as the maximum average drinks per day before supercritical behavior of the model, i.e. estimated as the x-intercept (−y_intercept/slope) of the previously estimated line, as presented in FIG. 8. It should be appreciated that alternative line fits may be implemented.

The Cognitive Minimal Model of Ethanol Dynamics:

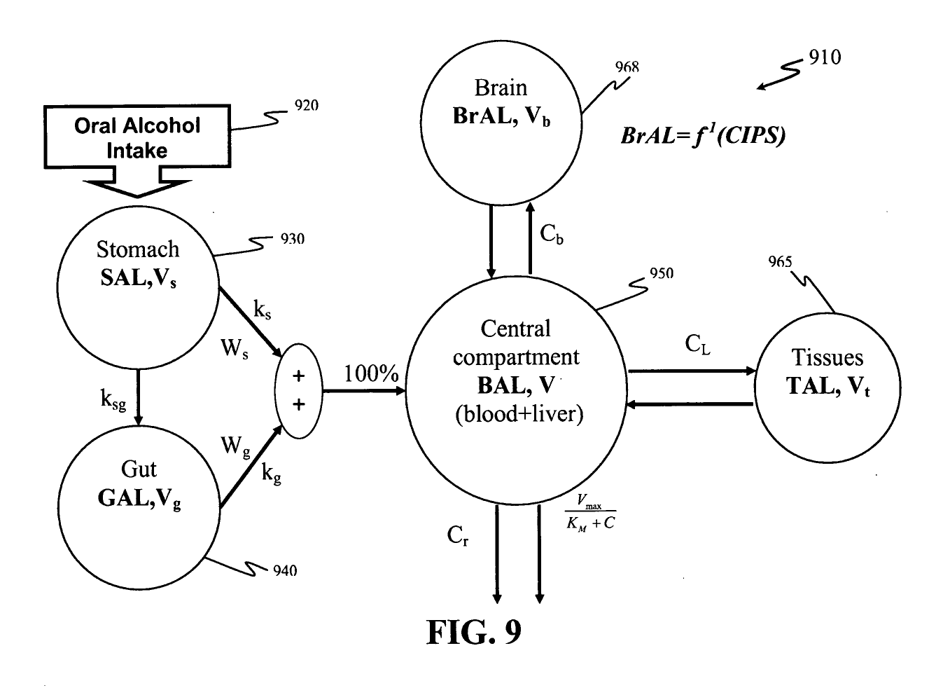

FIG. 9 presents and expansion of the metabolic model of ethanol dynamics for Cognitive Minimal Model of Ethanol Dynamics system 910, which includes a separate compartment for the brain 968, which has volume V_{b} and alcohol concentration BrAL, and the tissues related compartment 965. See FIG. 9.

Because the transport of ethanol through the blood brain barrier is very difficult to measure in vivo and because the individual rate of this transport does not necessarily reflect individual degree of cognitive dysfunction, the algorithm computing the cognitive alcohol sensitivity index establishes a direct correspondence between alcohol sensitivity and cognitive impairment. This is done via a transfer function mapping the dynamics of BrAL to the score changes in RVIPT. The assumption is that CIPS=ƒ(BrAL), where the transfer function ƒ(BrAL) can be linear, or of a certain class monotonously increasing functions, such as ƒ(BrAL)=γ.(1−exp(−α.BrAL^{β})). The equations of the minimal model are then augmented as follows:

$$\{ \begin{matrix}\frac{\partial BAL}{\partial t} = \frac{1}{{V}_{C} W} ( \begin{matrix}D ( t ) + {C}_{d} ( TAL ( t ) - BAL ( t ) ) + \\ {C}_{b} ( {B}_{r} AL ( t ) - BAL ( t ) ) - {C}_{r} BAL ( t ) - C ( t )\end{matrix} ) \\ \frac{\partial TAL}{\partial t} = \frac{{C}_{d}}{{V}_{T} W} ( BAL ( t ) - TAL ( t ) ) \\ \frac{\partial {B}_{r} AL}{\partial t} = \frac{{C}_{b}}{{V}_{B} W} ( BAL ( t ) - {B}_{r} AL ( t ) )\end{matrix}$$

From these equation, and given the alcohol intoxication profiles recorded during the clinical data collection protocol and the scores from cognitive testing, the transfer function ƒ(BrAL) is estimated via standard least squares procedure (or other applicable mathematical procedures). CASI is then defined as the maximum average drinks per day (or other applicable duration or interval as desired or required) before supercritical behavior of the cognitive model occurs, i.e. as the point where BrAL and associated cognitive impairments become permanently elevated.

An aspect of various embodiments of the present invention includes clinical and cognitive assessment protocols, mathematical methods, computer methods and systems/devices, and software for computing an estimate of ASI and CASI. The data used include blood alcohol level (BAL) readings and scores from rapid visual information processing task (RVIPT) recorded during a predetermined period following alcohol ingestion.

The availability of individual ASI and/or CASI would allow for precise assessment and individually tailored treatment of the metabolic and cognitive components of the alcohol addiction.

An aspect of various embodiments of the present invention may be utilized for a number of products and services, such as but not limited thereto, at least one of the following:

Individualized clinical assessment of alcohol addiction;

Standardized tests for addiction susceptibility; and

Individualized addiction treatment programs.

An aspect of various embodiments of the present invention may provide a number of exemplary and non-limiting advantages. The availability of individual ASI and/or CASI would allow for precise assessment and individually tailored treatment of the metabolic and cognitive components of the alcohol addiction. For example, the treatment goals could gradually change from an initial bringing of the patient under his/her individual supercritical threshold, thereby stabilizing his/her metabolic system, to complete alcohol independence.

It should be appreciated that the present invention methods, systems and computer program products may be utilized with the clinical aspects, methods, compositions, treatments and kits disclosed in the following patent applications that are hereby incorporated by reference in their entirety and co-owned by the assignee:

International Application No. PCT/US2008/064232 entitled “Medication Combinations for the Treatment of Alcoholism and Drug Addiction,” filed May 20, 2008;

International Application No. PCT/US2008/052628 entitled “Topiramate Plus Naltrexone for the Treatment of Addictive Disorders,” filed Jan. 31, 2008; and

International Application No. PCT/US2007/088100 entitled “Combined Effects of Topiramate and Ondansetron on Alcohol Consumption,” filed Dec. 19, 2007.

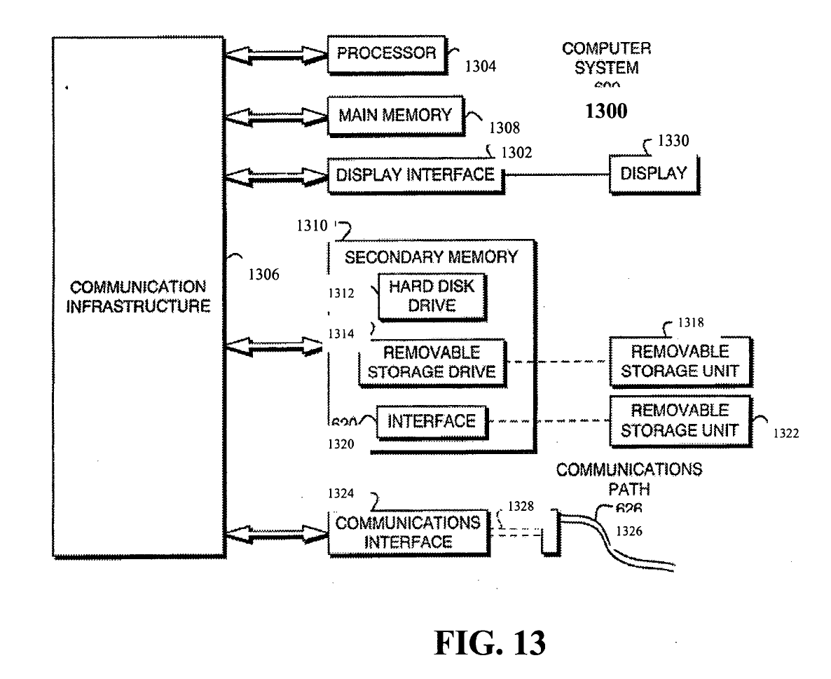

Turning to FIG. 13, FIG. 13 is a functional block diagram for a computer system 1300 for implementation of an exemplary embodiment or portion of an embodiment of present invention. For example, a method or system of an embodiment of the present invention may be implemented using hardware, software or a combination thereof and may be implemented in one or more computer systems or other processing systems, such as personal digit assistants (PDAs) equipped with adequate memory and processing capabilities. In an example embodiment, the invention was implemented in software running on a general purpose computer 1300 (or any suitable computer or processing device/system) as illustrated in FIG. 13. The computer system 1300 may includes one or more processors, such as processor 1304. The Processor 1304 is connected to a communication infrastructure 1306 (e.g., a communications bus, cross-over bar, or network). The computer system 1300 may include a display interface 1302 that forwards graphics, text, and/or other data from the communication infrastructure 1306 (or from a frame buffer not shown) for display on the display unit 1330. Display unit 1330 may be digital and/or analog.

The computer system 1300 may also include a main memory 1308, preferably random access memory (RAM), and may also include a secondary memory 1310. The secondary memory 1310 may include, for example, a hard disk drive 1312 and/or a removable storage drive 1314, representing a floppy disk drive, a magnetic tape drive, an optical disk drive, a flash memory, etc. The removable storage drive 1314 reads from and/or writes to a removable storage unit 1318 in a well known manner. Removable storage unit 1318, represents a floppy disk, magnetic tape, optical disk, etc. which is read by and written to by removable storage drive 1314. As will be appreciated, the removable storage unit 1318 includes a computer usable storage medium having stored therein computer software and/or data.

In alternative embodiments, secondary memory 1310 may include other means for allowing computer programs or other instructions to be loaded into computer system 1300. Such means may include, for example, a removable storage unit 1322 and an interface 1320. Examples of such removable storage units/interfaces include a program cartridge and cartridge interface (such as that found in video game devices), a removable memory chip (such as a ROM, PROM, EPROM or EEPROM) and associated socket, and other removable storage units 1322 and interfaces 1320 which allow software and data to be transferred from the removable storage unit 1322 to computer system 1300.

The computer system 1300 may also include a communications interface 1324. Communications interface 1324 allows software and data to be transferred between computer system 1300 and external devices. Examples of communications interface 1324 may include a modem, a network interface (such as an Ethernet card), a communications port (e.g., serial or parallel, etc.), a PCMCIA slot and card, a modem, etc. Software and data transferred via communications interface 1324 are in the form of signals 1328 which may be electronic, electromagnetic, optical or other signals capable of being received by communications interface 1324. Signals 1328 are provided to communications interface 1324 via a communications path (i.e., channel) 1326. Channel 1326 (or any other communication means or channel disclosed herein) carries signals 1328 and may be implemented using wire or cable, fiber optics, blue tooth, a phone line, a cellular phone link, an RF link, an infrared link, wireless link or connection and other communications channels.

In this document, the terms “computer program medium” and “computer usable medium” are used to generally refer to media or medium such as various software, firmware, disks, drives, removable storage drive 1314, a hard disk installed in hard disk drive 1312, and signals 1328. These computer program products (“computer program medium” and “computer usable medium”) are means for providing software to computer system 1300. The computer program product may comprise a computer useable medium having computer program logic thereon. The invention includes such computer program products. The “computer program product” and “computer useable medium” may be any computer readable medium having computer logic thereon.

Computer programs (also called computer control logic or computer program logic) are may be stored in main memory 1308 and/or secondary memory 1310. Computer programs may also be received via communications interface 1324. Such computer programs, when executed, enable computer system 1300 to perform the features of the present invention as discussed herein. In particular, the computer programs, when executed, enable processor 1304 to perform the functions of the present invention. Accordingly, such computer programs represent controllers of computer system 1300.

In an embodiment where the invention is implemented using software, the software may be stored in a computer program product and loaded into computer system 800 using removable storage drive 814, hard drive 812 or communications interface 824. The control logic (software or computer program logic), when executed by the processor 804, causes the processor 804 to perform the functions of the invention as described herein.

In another embodiment, the invention is implemented primarily in hardware using, for example, hardware components such as application specific integrated circuits (ASICs). Implementation of the hardware state machine to perform the functions described herein will be apparent to persons skilled in the relevant art(s).

In yet another embodiment, the invention is implemented using a combination of both hardware and software.

In an example software embodiment of the invention, the methods described above may be implemented in SPSS control language or C++ programming language, but could be implemented in other various programs, computer simulation and computer-aided design, computer simulation environment, MATLAB, or any other software platform or program, windows interface or operating system (or other operating system) or other programs known or available to those skilled in the art.

### Exemplary Software

Practice of the invention will be still more fully understood from the following exemplary and non-limiting software that may be implemented for the practice of an embodiment or portion of an embodiment of the present invention.

Data Processing Software:

The software for estimate the parameters of the Minimal Model of Ethanol Dynamics can be written in any programming language by those skilled in the art. Below is an example of software using MATLAB as a computing platform:

### Computation of ASI:

1. Blood ethanol is collected from an oral alcohol tolerance test see section E1
2. A gradient search, simplex, or other non linear optimization technique is used to minimize the distance between the predicted blood ethanol concentration course of the model and the collected data. Examples of distances include but are not restricted to: Euclidean norm (least squares), infinite norm (maximum), and weighted least squares.
3. At convergence the optimal parameters for that specific subjects a fixed.
4. Using the coefficients estimated above, the time course of BAL is computed for 70 days (˜100 000 minutes) using the previously described model, for average drinks per day ranging from 1 to 15 by 0.25 increments
   Non integer average drinks per day are attainable due to the randomness of the number of drinks for each day in the simulation.
   Average drinks per day are maintained by fixing the mean of the random variable ‘drinks per day’ at the desired value.
5. For each average number of drinks per day the average minimum BAL concentration is obtained for the 8 am-10 pm period.
6. All data points with values between 0.01 g/L and 0.1 g/L are selected.
7. A line is fit through this data using the linear least square fitting procedure. Slope and y-intercept are obtained.
8. ASI is calculated as the x-intercept or the opposite of the y-intercept over slope ratio.

### Computation of CASI—the Procedure is Similar to the One Described Above, Except for Two Modifications:

1. The equations of the cognitive minimal model is used instead of the equations of the metabolic minimal model; and
2. Brain alcohol level is indirectly estimated from the scores of a series of cognitive tests (RVIPT).

### EXAMPLES AND EXPERIMENTAL RESULTS

Practice of the invention will be still more fully understood from the following examples and experimental results, which are presented herein for illustration only and should not be construed as limiting the invention in any way.

Validation of the Method and Apparatus for Individual Assessment of Alcohol Sensitivity Via Computer Simulation

Prior to conducting clinical studies, a method of various embodiments of this invention has been validated via “in silico” experiments using computer simulation to reproduce key features of the ethanol metabolism system reported in the literature. The parameters of the metabolic minimal model of ethanol dynamics were first estimated using data available in the literature and from prior studies; then, the model was applied to study the behavior of the system during simulated drinking of 1 through >10 standard drinks dispersed randomly throughout an average day. Specifically:

Experimental Setting of the Computer Simulation:

The computer reproduced the system behavior over 72 drinking days. The simulation of a day of drinking was based on the generating of a typical drinking day, taking into account the given drinks per day average. For example, with 4 preset drinks per day on average, the computer generated a 72-day sequence of drinking days with any [e.g. between 1 and 15] number of drinks dispersed throughout each day amounting to 4 drinks/day on average. This was done by modeling a drinking day as a Wiener stochastic renewal process, which means that the time between drinks is a Gaussian (normal) random variable. To follow a more reasonable pattern of drinking we also limited the drinks to be between 7 AM and 11 PM, i.e. what we considered a standard daytime. The mean time between drinks was set at

$$\frac{minutes of daytime}{average number of drinks per day}$$

and its coefficient of variation was set at 20%. Each drink was standardized and set to be equivalent to a glass of wine, 12 g of ethanol in 100 ml (3.5 oz), drank in 5 minutes. The simulation was run for 72 days (100,000 minutes) in a standard man model (70 kg). The time course of BAL was recorded for each run. The range of average drinks per day was limited to between 1 and 15. Initial settings for identifying the\ Minimal Model of Ethanol Dynamics were adopted from the literature: Cₘₐₓ=0.1614 g/L, tₘₐₓ=47 min, and AUC=0.23 g·h/L (area under the curve) [16, 24, 25].

Two outcome measures were analyzed from this “in silico” experiment: the minimum of blood ethanol concentration over daytime and over 24 hours. Each measure was calculated for each day between day 10 and 72, avoiding the initiation period of 9 days to allow the system to become stationary); the mean BAL was computed as well.

Results:

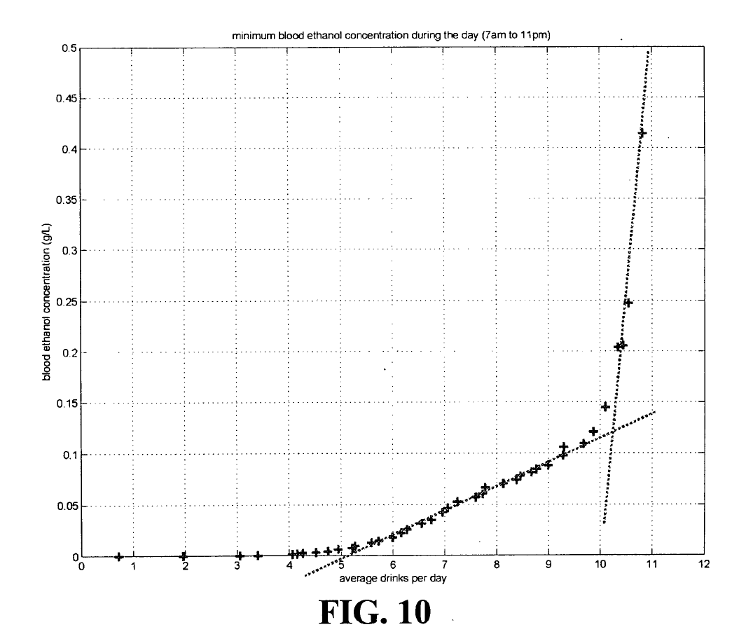

FIG. 9 presents the minimum BAL during daytime as a function of the average number of drinks per day (ADD). In other words, the line represents whether BAL would ever go down to zero during the day, or not. The computer simulation shows that with up to 5 drinks per day on average, the minimum BAL during daytime is zero, indicating the system reaches its steady (sober) state at least for a while during the day. Between 5 and 11 drinks there is a baseline a linear increase of the minimum BAL (slope: 0.0235, R²=0.99). After 11 drinks per day the slope of the linear relationship increases dramatically to 1.71 (R²=1). See FIG. 10.

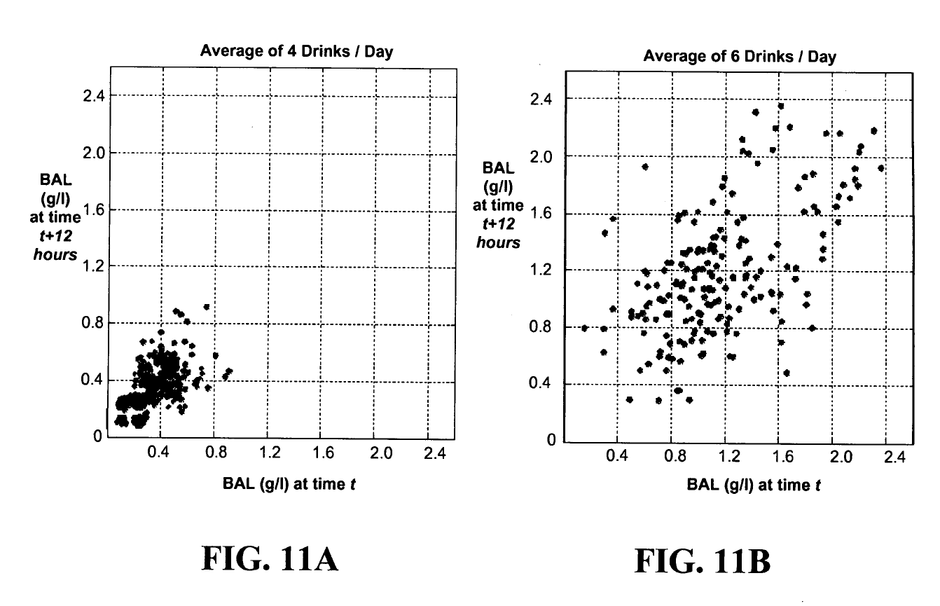

Thus, the computer simulation indicates that there are two well-defined threshold points defining abrupt system changes: 5 and 11 drinks/day on average. The first threshold point, at 5 drinks per day, indicates the transition of zero vs. non-zero daily (7 AM-11 PM) BAL minimum. This means that with 4 drinks or less, the system is still capable of fully metabolizing the ingested alcohol, while at 5 or more drinks per day, there is always a certain residual alcohol amount. From a system biology point of view, this first critical point indicates a phase transition from stable to unstable system dynamics. This is well visualized by the Poincaré plots in FIG. 10. See FIG. 11.

As seen in FIG. 10 five or more drinks per day would cause metabolic perturbations never allowing the system to come to rest: the left panel represents a sustainable system dynamics, while the right panel represents a system that is clearly out of control.

This computer simulation result is consistent with, and to some degree explains at a system physiology level, the generally accepted understanding of heavy drinking defined as 5 or more drinks per day. It appears that this critical value is not only an empirically established threshold, but also an indication of an abrupt metabolic phase transition.

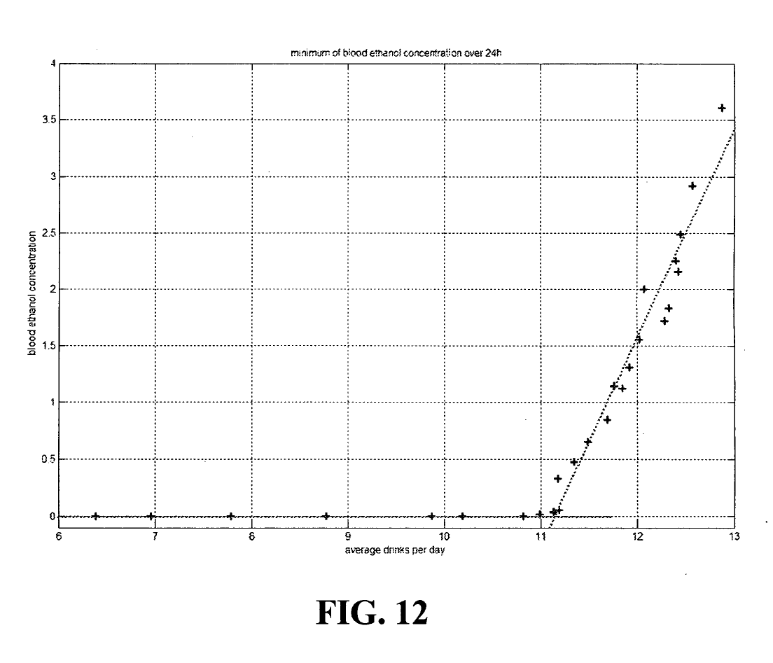

In order to explain the second threshold value of 11 drinks/day we need to look at the night time. As presented in FIG. 11, the minimum BAL during the night (11 PM-7 AM, which was simulated as free of drinking) reaches zero for up to 11 drinks consumed during the day (7 AM-11 PM). When the number of drinks during the day exceeds 11, the system cannot metabolize the amount of consumed alcohol even during the nighttime hours, which are free of drinking. See FIG. 12.

Thus, 11 or more standard drinks per day result in a transition of the system dynamics to a higher blood ethanol value, which never goes down to zero. Because every morning there is still residual ethanol in the bloodstream, there is a very steep rise of BAL after 11 or more drinks/day. This explains the abrupt change in the slope of the dependence of BAL on average drinks per day depicted in FIG. 9.

In summary, the metabolic minimal model of ethanol dynamics is capable of reproducing (via computer simulation) and to some degree explaining the well known empirical definition of heavy drinking, defined as 5 or more drinks/day on average. The model also suggests other extreme situations, such as those that would occur with more than 11 drinks/day, which should theoretically result in a permanent cognitive impairment due to continuous alcohol intoxication.

In this computer simulation we used average parameters of alcohol metabolism. The minimal model of ethanol dynamics will allow for the computation of such parameters for each individual. This in turn is expected to facilitate the tailoring of individualized treatment.

### REFERENCES

The following patents, applications and publications as listed below and throughout this document are hereby incorporated by reference in their entirety herein. The devices, systems, computer systems, computer program products, computer products and methods of various embodiments of the invention disclosed herein may utilize aspects disclosed in the following references, applications, publications and patents and which are hereby incorporated by reference herein in their entirety:
1. Basu A., Dalla Man C., Toffolo G., Basu R., Cobelli C., Rizza A., Effect of Type 2 Diabetes on Meal Glucose Fluxes and Insulin Secretion. Diabetes. 53 (suppl. 2), A579, 2004.
2. Bergman R N, Finegood D T, Ader M. Assessment of insulin sensitivity in vivo. Am J Physiol 236:E667-677, 1985
3. Bergman R N, Ider Y Z, Bowden C R, Cobelli C. Quantitative estimation of insulin sensitivity. Am J Physiol. 236: E667-E677, 1979
4. Bergman R N. The minimal model of glucose regulation: a biography. Advances in Experimental Medicine & Biology 537:1-19, 2003
5. Bergman R N. Zaccaro D J. Watanabe R M. Haffner S M. Saad M F. Norris J M. Wagenknecht L E. Hokanson J E. Rotter J I. Rich S S. Minimal model-based insulin sensitivity has greater heritability and a different genetic basis than homeostasis model assessment or fasting insulin. Diabetes 52:2168-74, 2003
6. Breda E, Cavaghan M K, Toffolo G, Polonsky K S, and Cobelli C. Oral glucose tolerance test minimal model indexes of beta-cell function and insulin sensitivity. Diabetes 50:150-158, 2001
7. Caumo A. Bergman R N. Cobelli C. Insulin sensitivity from meal tolerance tests in normal subjects: a minimal model index. Journal of Clinical Endocrinology & Metabolism. 85:4396-402, 2000
8. Clausen J O. Borch-Johnsen K. Ibsen H. Bergman R N. Hougaard P. Winther K. Pedersen O. Insulin sensitivity index, acute insulin response, and glucose effectiveness in a population-based sample of 380 young healthy Caucasians. Analysis of the impact of gender, body fat, physical fitness, and life-style factors. Journal of Clinical Investigation 98:1195-209, 1996
9. Cortot A, Jobin G, Ducrot F, et al. Gastric emptying and gastrointestinal absorption of alcohol ingested with a meal. Dig Dis Sci 1986; 31: 343-8
10. Dalla Man C, Caumo A, and Cobelli C. The oral glucose minimal model: estimation of insulin sensitivity from a meal test. IEEE Trans Biomed Eng 49: 419-429, 2002
11. Dalla Man C, Caumo A, Basu R, Rizza R, Toffolo G, and Cobelli C. Minimal model estimation of glucose absorption and insulin sensitivity from oral test: validation with a tracer method. Am J Physiol Endocrinol Metab 287: E637-E643, 2004
12. Dalla Man C, Caumo A, Basu R, Rizza R, Toffolo G, and Cobelli C. Measurement of selective effect of insulin on glucose disposal from labeled glucose oral test minimal model. Am J Physiol Endocrinol Metab 289: E909-E914, 2005
13. DeFronzo R A, Tobin J D and Andres R. Glucose clamp technique: A method for quantifying insulin secretion and resistance. Amer J Physiol 237: E214-223, 1979
14. Elahi D. In praise of the hyperglycemic clamp: a method for assessment of β-cell sensitivity and insulin resistance. Diabetes Care 19: 278-286, 1996.
15. Flier J S: Syndromes of insulin resistance. In: Becker K L, ed. Principles and Practice of Endocrinology & Metabolism, 2nd ed. Philadelphia, Pa.: JB Lippincott Company; 1995: 1245-1259
16. Fraser A G, Rosalki S B, Gamble G D, et al. Inter-individual and intra-individual variability of ethanol concentration-time profiles: comparison of ethanol ingestion before or after an evening meal. Br J Clin Pharmacol 1995; 40: 387-92
17. Johnson B A, Oldman D, Goodall E M, Chen Y R, Cowen P J. Effects of GR68755 on d-amphetamine-induced changes in mood, cognitive performance, appetite, food preference, and caloric and macronutrient intake in humans. Behav Pharmacol 1996; 7: 216-27.
18. Kjems L L, Volund A, Madsbad S. Quantification of beta-cell function during IVGTT in Type II and non-diabetic subjects: assessment of insulin secretion by mathematical methods. Diabetologia 44: 1339-1348, 2001
19. Liefmann R. Endocrine imbalance in rheumatoid arthritis and rheumatoid spondylitis; hyperglycemia unresponsiveness, insulin resistance, increased gluconeogenesis and mesenchymal tissue degeneration; preliminary report. Acta Med Scand. 136: 226-32, 1949
20. Matsumoto H., Fukui Y. Pharmacokinetics of ethanol: a review of the methodology. Addiction Biology 2002, 7: 5-14
21. Mumenthaler M S, Taylor J L, Yesavage J A. Ethanol pharmacokinetics in white women: nonlinear model fitting versus zero order elimination analyses. Alcohol Clin Exp Res 2000; 24: 1353-62
22. Ni T C. Ader M. Bergman R N. Reassessment of glucose effectiveness and insulin sensitivity from minimal model analysis: a theoretical evaluation of the single-compartment glucose distribution assumption. Diabetes 46:1813-21, 1997
23. Norberg A, Gabrielsson J, Jones A W, et al. Within- and between-subject variations in pharmacokinetic parameters of ethanol by analysis of breath, venous blood and urine. Br J Clin Pharmacol 2000; 49: 399-408
24. Norberg A., Jones A. W. Hahn R. G., Gabrielsson J. L. Role of Variability in Explaining Ethanol Pharmacokinetics. Clin. Pharmacokinet. 2003, 42 (1): 1-31
25. Oneta C M, Simanowski U A, Martinez M, et al. First pass metabolism of ethanol is strikingly influenced by the speed of gastric emptying. Gut 1998; 43: 612-9
26. Reaven G M: Pathophysiology of insulin resistance in human disease. Physiol Rev. 75: 473-86, 1995
27. Silverstone P H, Oldman D, Johnson B, Cowen P J. Ondansetron, a5-HT3 receptor antagonist, partially attenuates the effects of amphetamine: a pilot study in healthy volunteers. Int Clin Psychopharmacol 1992; 7: 37-43.
28. Steil G M, Hwu C, Janowski R, Hariri F, Jinagouda S, Darwin C, Tadros S, Rebrin K, Saad M F. Evaluation of insulin sensitivity and beta-cell function indexes obtained from minimal model analysis of a meal tolerance test. Diabetes 53: 1201-07, 2004
29. Toffolo G, Breda E, Cavaghan M K, Ehrmann D A, Polonsky K S, and Cobelli C. Quantitative indexes of beta-cell function during graded up & down glucose infusion from C-peptide minimal models. Am J Physiol Endocrinol Metab 280: E2-E10, 2001
30. Toffolo G, Cefalu W T, Cobelli C: β-cell function during insulin-modified intravenous glucose tolerance test successfully assessed by the C-peptide minimal model. Metabolism 48:1162-1166, 1999
31. Toffolo G, DeGrandi F, Cobelli C: Estimation of β-cell sensitivity from intravenous glucose tolerance tests C-peptide data. Diabetes 44: 845-854, 1995
32. Umulis D. M., Gürmen N. M., Singh P., Fogler H. S. A Physiologically based model for ethanol and acetaldehyde metabolism in human beings. Alcohol 2005, 35: 3-12
33. Wardl R J and Ch. Coutelle: Women and alcohol susceptibility: Could differences in alcohol metabolism predispose women to alcohol-related diseases? Arch Womens Ment Health (2003) 6:231-238
34. Welch S. Gebhart S S. Bergman R N. Phillips L S. Minimal model analysis of intravenous glucose tolerance test-derived insulin sensitivity in diabetic subjects. Journal of Clinical Endocrinology & Metabolism 71:1508-18, 1990
35. Widmark E M P. Die theoretischen Grundlagen and die praktische Verwendbarkeit der gerichtlich-medizinischen Alkoholbestimmung. Berlin: Urban & Schwarzenberg, 1932
36. Willms B., Werner J., Holst J. J., Orskov C., Creutzfeldt W., Nauck M. A. Gastric Emptying, Glucose Responses, and Insulin Secretion after a liquid Test Meal: Effect of Exogenous Glucagon-Like Peptide-1 (GLP-1)-(7-36) Amide in type 2 (Noninsulin-Dependent) Diabetic Patients. J. Clin. Endo. Metab. 1996, 81 (1): 327-332
U.S. Pat. No. 7,033,771 to Brooks, Cydney, entitled “Use of Insulin Response Modulators in the Treatment of Diabetes and Insulin Resistance, Apr. 25, 2006.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A computer implemented method for evaluating idiosyncratic estimates of alcohol sensitivity of a subject, said estimates being represented by one or more idiosyncratic indices, wherein said idiosyncratic indices may comprise:
calculating an alcohol sensitivity index (ASI), or
calculating a cognitive alcohol sensitivity index (CASI).

2. The method of claim 1, wherein said cognitive alcohol sensitivity index (CASI) comprises:
said an alcohol sensitivity index (ASI); and
calculating a transfer function, said transfer function for quantifying a simulated measure of alcohol level in the brain (BrAL)

3. The method of claim 1, further comprising providing a metabolic minimal simulation model of alcohol dynamics (MMSMAD) following oral intake by the subject for computing said alcohol sensitivity index (ASI).

4. The method of claim 3, wherein said alcohol sensitivity index (ASI) equates to the number of drinks per a predetermined duration that a subject may consume before supercritical behavior of said metabolic minimal simulation model of alcohol dynamics (MMSMAD) occurs.

5. The method of claim 4, wherein said predetermined duration is a day.

6. The method of claim 4, wherein said predetermined duration is greater than a day.

7. The method of claim 4, wherein said predetermined duration is less than a day.

8. The method of claim 3, further comprising a providing cognitive minimal simulation model of alcohol dynamics (CMSMAD) for computing said cognitive alcohol sensitivity index (CASI).

9. The method of claim 8, wherein said cognitive alcohol sensitivity index (CASI) equates to the number of drinks per a predetermined duration that a subject may consume before supercritical behavior of said cognitive minimal simulation model of alcohol dynamics (CMSMAD) occurs.

10. The method of claim 9, wherein said predetermined duration is a day.

11. The method of claim 9, wherein said predetermined duration is greater than a day.

12. The method of claim 9, wherein said predetermined duration is less than a day.

13. The method of claim 9, wherein said supercritical behavior represents a condition that alcohol level in the brain (BrAL) and associated impairments become permanently elevated.

14. The method of claim 8, further comprising:
establishing alcohol intoxication profiles recorded during a clinical collection protocol;
obtaining cognitive testing scores; and
calculating the transfer function, ƒ(BrAL).

15. The method of claim 3, further comprising:
establishing alcohol intoxication profiles recorded during a clinical collection protocol; and
estimating parameters of said metabolic minimal simulation model of alcohol dynamics (MMSMAD).

16. The method of claim 1, further comprising:
applying said ASI and/or CASI for providing assessment and individually tailored treatment of the metabolic and cognitive components of the alcohol addiction for the subject.

17. The method of claim 1, further comprising:
applying said ASI and/or CASI for providing individualized clinical assessment of alcohol addiction for the subject.

18. The method of claim 1, further comprising:
applying said ASI and/or CASI for providing standardized tests for addiction susceptibility for the subject.

19. The method of claim 1, further comprising:
applying said ASI and/or CASI for providing for individualized addiction treatment programs for the subject.

20. The method of claim 1, further comprising: calculating both said alcohol sensitivity index (ASI) and said cognitive alcohol sensitivity index (CASI).

21. A system for evaluating idiosyncratic estimates of alcohol sensitivity of a subject, wherein said estimates being represented by one or more idiosyncratic indices, and said system comprising a processor that determines said idiosyncratic indices by:
calculating an alcohol sensitivity index (ASI), or
calculating a cognitive alcohol sensitivity index (CASI).

22. The system of claim 21, further comprising a metabolic minimal simulation model of alcohol dynamics (MMSMAD) module for computing said alcohol sensitivity index (ASI).

23. The system of claim 21, further comprising a cognitive minimal simulation model of alcohol dynamics (CMSMAD) module for computing said cognitive alcohol sensitivity index (CASI).

24. The system of claim 21, further comprising: calculating both said alcohol sensitivity index (ASI) and said cognitive alcohol sensitivity index (CASI).

25. A computer program product comprising a computer useable medium having computer program logic for enabling at least one processor in a computer system for evaluating idiosyncratic estimates of alcohol sensitivity of a subject, wherein said estimates being represented by one or more idiosyncratic indices, and said evaluating method of said computer program logic comprising:
calculating an alcohol sensitivity index (ASI), or
calculating a cognitive alcohol sensitivity index (CASI).

26. The computer program product of claim 25, further comprising said processor adapted for calculating a metabolic minimal simulation model of alcohol dynamics (MMSMAD) module for computing said alcohol sensitivity index (ASI).

27. The computer program product of claim 25, further comprising said processor adapted for calculating a cognitive minimal simulation model of alcohol dynamics (CMSMAD) module for computing said cognitive alcohol sensitivity index (CASI).

28. The computer program product of claim 25, further comprising: calculating both said alcohol sensitivity index (ASI) and said cognitive alcohol sensitivity index (CASI).
